(19) United States
(12) Patent Application Publication
(10) Pub. No.: US 2013/0155001 A1
(43) Pub. Date: Jun. 20, 2013

(54) Low-Resistance Electrodes

(71) Applicants: Esat Yilmaz, Santa Cruz, CA (US); David Brent Guard, Hamphsire (GB); Jalil Shaikh, Fremont, CA (US); Michael Thomas Morrione, San Jose, CA (US)

(72) Inventors: Esat Yilmaz, Santa Cruz, CA (US); David Brent Guard, Hamphsire (GB); Jalil Shaikh, Fremont, CA (US); Michael Thomas Morrione, San Jose, CA (US)

(21) Appl. No.: 13/330,443

(22) Filed: Dec. 19, 2011

(51) Int. Cl. G06F 3/045

(52) U.S. Cl. 345/174

(57) ABSTRACT

In one embodiment, an apparatus includes one or more substrates and a touch sensor disposed on one or more of the substrates. The touch sensor has a substantially transparent electrode made of lines of substantially opaque conductive material and the substantially transparent electrode having an effective sheet resistance within a range of approximately 5 to approximately 20 ohms per square.

### TECHNICAL FIELD

This disclosure generally relates to touch sensors.

### BACKGROUND

A touch position sensor may detect the presence and location of a touch or the proximity of an object (such as a user's finger or a stylus) within a touch-sensitive area of the touch sensor overlaid on a display screen, for example. In a touch-sensitive display application, the touch position sensor may enable a user to interact directly with what is displayed on the screen, rather than indirectly with a mouse or touch pad. A touch sensor may be attached to or provided as part of a desktop computer, laptop computer, tablet computer, personal digital assistant (PDA), smartphone, satellite navigation device, portable media player, portable game console, kiosk computer, point-of-sale device, or other suitable device. A control panel on a household or other appliance may include a touch sensor.

There are a number of different types of touch position sensors, such as (for example) resistive touch screens, surface acoustic wave touch screens, and capacitive touch screens. Herein, reference to a touch sensor may encompass a touch screen, and vice versa, where appropriate. When an object touches or comes within proximity of the surface of the capacitive touch screen, a change in capacitance may occur within the touch screen at the location of the touch or proximity. A controller may process the change in capacitance to determine its position on the touch screen.

### BRIEF DESCRIPTION OF THE DRAWINGS

FIG. 1 illustrates an example touch sensor with an example controller.

FIGS. 2A-C illustrate example mesh patterns.

FIG. 3 illustrates an example device incorporating a touch sensor.

### DESCRIPTION OF EXAMPLE EMBODIMENTS

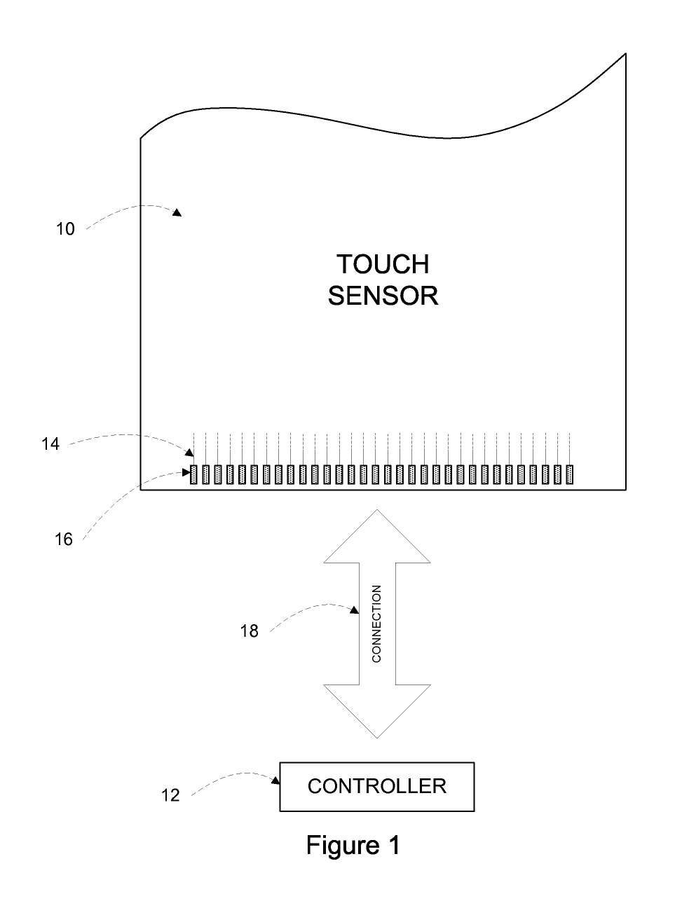

FIG. 1 illustrates an example touch sensor 10 with an example controller 12. Herein, reference to a touch sensor may encompass a touch screen, and vice versa, where appropriate. Touch sensor 10 and controller 12 may detect the presence and location of a touch or the proximity of an object within a touch-sensitive area of touch sensor 10. Herein, reference to a touch sensor may encompass both the touch sensor and its controller, where appropriate. Similarly, reference to a controller may encompass both the controller and its touch sensor, where appropriate. Touch sensor 10 may include one or more touch-sensitive areas, where appropriate. Touch sensor 10 may include an array of drive and sense electrodes (or an array of electrodes of a single type) disposed on one or more substrates, which may be made of a dielectric material. Herein, reference to a touch sensor may encompass both the electrodes of the touch sensor and the substrate(s) that they are disposed on, where appropriate. Alternatively, where appropriate, reference to a touch sensor may encompass the electrodes of the touch sensor, but not the substrate(s) that they are disposed on.

An electrode (whether a drive electrode or a sense electrode) may be an area of conductive material forming a shape, such as for example a disc, square, rectangle, other suitable shape, or suitable combination of these. In particular embodiments, the conductive material of an electrode may occupy approximately 100% of the area of its shape. As an example and not by way of limitation, an electrode may be made of indium tin oxide (ITO) and the ITO of the electrode may occupy approximately 100% of the area of its shape, where appropriate. In particular embodiments, the conductive material of an electrode may occupy approximately 5% of the area of its shape, as described below. Although this disclosure describes or illustrates particular electrodes made of particular conductive material forming particular shapes with particular fills having particular patterns, this disclosure contemplates any suitable electrodes made of any suitable conductive material forming any suitable shapes with any suitable fills having any suitable patterns. Where appropriate, the shapes of the electrodes (or other elements) of a touch sensor may constitute in whole or in part one or more macro-features of the touch sensor. One or more characteristics of the implementation of those shapes (such as, for example, the conductive materials, fills, or patterns within the shapes) may constitute in whole or in part one or more micro-features of the touch sensor. One or more macro-features of a touch sensor may determine one or more characteristics of its functionality, and one or more micro-features of the touch sensor may determine one or more optical features of the touch sensor, such as transmittance, refraction, or reflection.

One or more portions of the substrate of touch sensor 10 may be made of polyethylene terephthalate (PET) or another suitable material. In particular embodiments, the substrate may be made using substantially flexible material, such that structural integrity of the substrate is maintained after significant deformation. As an example and not by way of limitation, a substrate made of substantially flexible material may enable one or more portions of the flexible substrate to wrap around an edge of a surface. This disclosure contemplates any suitable substrate with any suitable portions made of any suitable material. In particular embodiments, the drive or sense electrodes in touch sensor 10 may be made of ITO in whole or in part. In particular embodiments, the drive or sense electrodes in touch sensor 10 may be made of fine lines of metal or other conductive material.

A mechanical stack may contain the substrate (or multiple substrates) and the conductive material forming the drive or sense electrodes of touch sensor 10. As an example and not by way of limitation, the mechanical stack may include a first layer of optically clear adhesive (OCA) beneath a cover panel. The cover panel may be clear and made of a resilient material suitable for repeated touching, such as for example glass, polycarbonate, or poly(methyl methacrylate) (PMMA). This disclosure contemplates any suitable cover panel made of any suitable material. The first layer of OCA may be disposed between the cover panel and the substrate with the conductive material forming the drive or sense electrodes. The mechanical stack may also include a second layer of OCA and a dielectric layer (which may be made of PET or another suitable material, similar to the substrate with the conductive material forming the drive or sense electrodes) or a thin coating of a dielectric material. The second layer of OCA may be disposed between the substrate with the conductive material making up the drive or sense electrodes and the dielectric layer, and the dielectric layer may be disposed between the second layer of OCA and an air gap to a display of a device including touch sensor 10 and controller 12. As an example and not by way of limitation, the cover panel may have a thickness of approximately 1 millimeter (mm); the first layer of OCA may have a thickness of approximately 0.05 mm; the substrate with the conductive material forming the drive or sense electrodes may have a thickness of approximately 0.05 mm; the second layer of OCA may have a thickness of approximately 0.05 mm; and the dielectric layer may have a thickness of approximately 0.05 mm. Although this disclosure describes a particular mechanical stack with a particular number of particular layers made of particular materials and having particular thicknesses, this disclosure contemplates any suitable mechanical stack with any suitable number of any suitable layers made of any suitable materials and having any suitable thicknesses. As an example and not by way of limitation, in particular embodiments, a layer of adhesive or dielectric may replace the dielectric layer, second layer of OCA, and air gap described above, with there being no air gap to the display.

Touch sensor 10 may implement a capacitive form of touch sensing. In a mutual-capacitance implementation, touch sensor 10 may include an array of drive and sense electrodes forming an array of capacitive nodes. A drive electrode and a sense electrode may form a capacitive node. The drive and sense electrodes forming the capacitive node may come near each other, but not make electrical contact with each other. Instead, the drive and sense electrodes may be capacitively coupled to each other across a space between them. A pulsed or alternating voltage applied to the drive electrode (by controller 12) may induce a charge on the sense electrode, and the amount of charge induced may be susceptible to external influence (such as a touch or the proximity of an object). When an object touches or comes within proximity of the capacitive node, a change in capacitance may occur at the capacitive node and controller 12 may measure the change in capacitance. By measuring changes in capacitance throughout the array, controller 12 may determine the position of the touch or proximity within the touch-sensitive area(s) of touch sensor 10.

In a self-capacitance implementation, touch sensor 10 may include an array of electrodes of a single type that may each form a capacitive node. When an object touches or comes within proximity of the capacitive node, a change in self-capacitance may occur at the capacitive node and controller 12 may measure the change in capacitance, for example, as a change in the amount of charge needed to raise the voltage at the capacitive node by a pre-determined amount. As with a mutual-capacitance implementation, by measuring changes in capacitance throughout the array, controller 12 may determine the position of the touch or proximity within the touch-sensitive area(s) of touch sensor 10. This disclosure contemplates any suitable form of capacitive touch sensing, where appropriate.

In particular embodiments, one or more drive electrodes may together form a drive line running horizontally or vertically or in any suitable orientation. Similarly, one or more sense electrodes may together form a sense line running horizontally or vertically or in any suitable orientation. In particular embodiments, drive lines may run substantially perpendicular to sense lines. Herein, reference to a drive line may encompass one or more drive electrodes making up the drive line, and vice versa, where appropriate. Similarly, reference to a sense line may encompass one or more sense electrodes making up the sense line, and vice versa, where appropriate.

Touch sensor 10 may have drive and sense electrodes disposed in a pattern on one side of a single substrate. In such a configuration, a pair of drive and sense electrodes capacitively coupled to each other across a space between them may form a capacitive node. For a self-capacitance implementation, electrodes of only a single type may be disposed in a pattern on a single substrate. In addition or as an alternative to having drive and sense electrodes disposed in a pattern on one side of a single substrate, touch sensor 10 may have drive electrodes disposed in a pattern on one side of a substrate and sense electrodes disposed in a pattern on another side of the substrate. Moreover, touch sensor 10 may have drive electrodes disposed in a pattern on one side of one substrate and sense electrodes disposed in a pattern on one side of another substrate. In such configurations, an intersection of a drive electrode and a sense electrode may form a capacitive node. Such an intersection may be a location where the drive electrode and the sense electrode “cross” or come nearest each other in their respective planes. The drive and sense electrodes do not make electrical contact with each other—instead they are capacitively coupled to each other across a dielectric at the intersection. Although this disclosure describes particular configurations of particular electrodes forming particular nodes, this disclosure contemplates any suitable configuration of any suitable electrodes forming any suitable nodes. Moreover, this disclosure contemplates any suitable electrodes disposed on any suitable number of any suitable substrates in any suitable patterns.

As described above, a change in capacitance at a capacitive node of touch sensor 10 may indicate a touch or proximity input at the position of the capacitive node. Controller 12 may detect and process the change in capacitance to determine the presence and location of the touch or proximity input. Controller 12 may then communicate information about the touch or proximity input to one or more other components (such one or more central processing units (CPUs) or digital signal processors (DSPs)) of a device that includes touch sensor 10 and controller 12, which may respond to the touch or proximity input by initiating a function of the device (or an application running on the device) associated with it. Although this disclosure describes a particular controller having particular functionality with respect to a particular device and a particular touch sensor, this disclosure contemplates any suitable controller having any suitable functionality with respect to any suitable device and any suitable touch sensor.

Controller 12 may be one or more integrated circuits (ICs)—such as for example general-purpose microprocessors, microcontrollers, programmable logic devices (PLDs) or arrays (PLAs), application-specific ICs (ASICs)—on a flexible printed circuit (FPC) bonded to the substrate of touch sensor 10, as described below. Controller 12 may include a processor unit, a drive unit, a sense unit, and a storage unit. The drive unit may supply drive signals to the drive electrodes of touch sensor 10. The sense unit may sense charge at the capacitive nodes of touch sensor 10 and provide measurement signals to the processor unit representing capacitances at the capacitive nodes. The processor unit may control the supply of drive signals to the drive electrodes by the drive unit and process measurement signals from the sense unit to detect and process the presence and location of a touch or proximity input within the touch-sensitive area(s) of touch sensor 10. The processor unit may also track changes in the position of a touch or proximity input within the touch-sensitive area(s) of touch sensor 10. The storage unit may store programming for execution by the processor unit, including programming for controlling the drive unit to supply drive signals to the drive electrodes, programming for processing measurement signals from the sense unit, and other suitable programming, where appropriate. Although this disclosure describes a particular controller having a particular implementation with particular components, this disclosure contemplates any suitable controller having any suitable implementation with any suitable components.

Tracks 14 of conductive material disposed on the substrate of touch sensor 10 may couple the drive or sense electrodes of touch sensor 10 to connection pads 16, also disposed on the substrate of touch sensor 10. As described below, connection pads 16 facilitate coupling of tracks 14 to controller 12. Tracks 14 may extend into or around (e.g. at the edges of) the touch-sensitive area(s) of touch sensor 10. Particular tracks 14 may provide drive connections for coupling controller 12 to drive electrodes of touch sensor 10, through which the drive unit of controller 12 may supply drive signals to the drive electrodes. Other tracks 14 may provide sense connections for coupling controller 12 to sense electrodes of touch sensor 10, through which the sense unit of controller 12 may sense charge at the capacitive nodes of touch sensor 10. Tracks 14 may be made of fine lines of metal or other conductive material. As an example and not by way of limitation, the conductive material of tracks 14 may be copper or copper-based and have a width of approximately 100 microns (μm) or less. As another example, the conductive material of tracks 14 may be silver or silver-based and have a width of approximately 100 μm or less. In particular embodiments, tracks 14 may be made of ITO in whole or in part, in addition or as an alternative to fine lines of metal or other conductive material. Although this disclosure describes particular tracks made of particular materials with particular widths, this disclosure contemplates any suitable tracks made of any suitable materials with any suitable widths. In addition to tracks 14, touch sensor 10 may include one or more ground lines terminating at a ground connector (which may be a connection pad 16) at an edge of the substrate of touch sensor 10 (similar to tracks 14).

Connection pads 16 may be located along one or more edges of the substrate, outside the touch-sensitive area(s) of touch sensor 10. As described above, touch-sensor controller 12 may be on an FPC. Connection pads 16 may be made of the same material as tracks 14 and may be bonded to the FPC using an anisotropic conductive film (ACF). Connection 18 may include conductive lines on the FPC coupling touch-sensor controller 12 to connection pads 16, in turn coupling touch-sensor controller 12 to tracks 14 and to the drive or sense electrodes of touch sensor 10. In another embodiment, connection pads 16 may be connected to an electro-mechanical connector (such as a zero insertion force wire-to-board connector); in this embodiment, connection 18 may not need to include an FPC. This disclosure contemplates any suitable connection 18 between touch-sensor controller 12 and touch sensor 10.

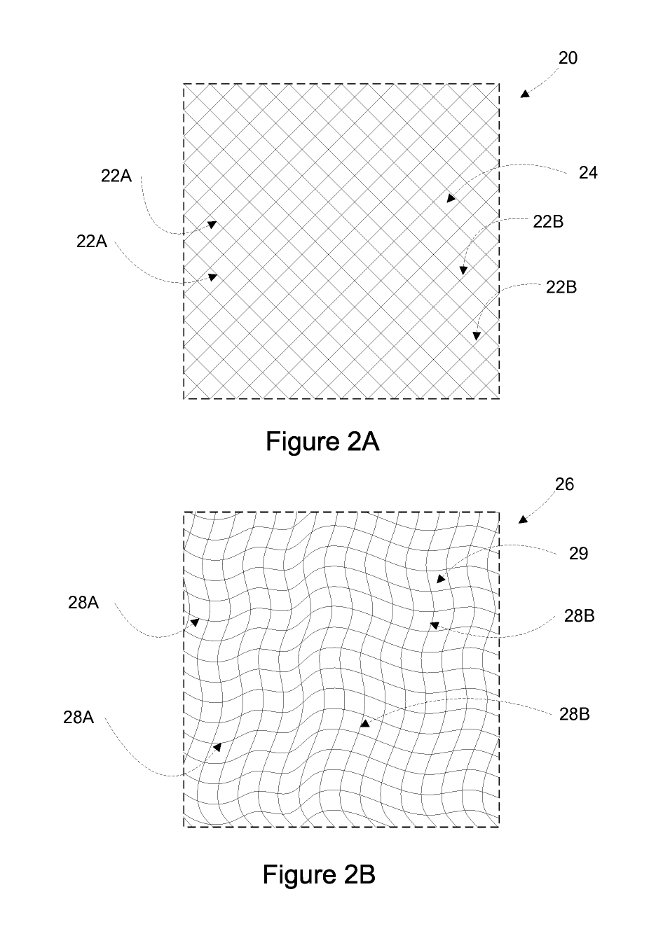

FIGS. 2A-2C illustrate example mesh patterns of a touch-sensitive layer. One or more cuts in the example mesh patterns of FIGS. 2A-2C may (at least in part) form one or more shapes (e.g. electrode or fills) of the touch sensor, and the area of the shape may (at least in part) be bounded by those cuts. The example meshes mesh patterns of FIGS. 2A-2C may be made from fine lines of metal (e.g., copper, silver, or copper- or silver-based material) or other conductive material. In the example of FIG. 2A, an example mesh pattern 20 may be formed from substantially straight lines 22A-B of conductive material. Mesh pattern 20 may be formed using two sets 22A-B of substantially parallel lines of conductive material with orientation shifted by approximately 90°. The sets 22A-B of conductive lines may have substantially orthogonal intersections that form an array of diamond-shaped mesh cells 24 in mesh pattern 20.

In the example of FIG. 2B, mesh pattern 26 may be formed from two sets of substantially non-linear conductive lines 28A-B with differing orientation. In particular embodiments, non-linear line 28A-B patterns may be used to avoid long linear stretches of fine metal with a repeat frequency, reducing a probability of causing interference or moiré patterns. The non-linear pattern of the conductive lines 28A-B of mesh pattern 26 may disperse and hence reduce the visibility of reflections from conductive lines 28A-B when illuminated by incident light. As an example and not by way of limitation, each of conductive lines 28A-B of mesh pattern 26 may have a substantially sinusoidal shape. The sets 28A-28B of substantially non-linear conductive lines may have substantially non-orthogonal intersections that form an array of mesh cells 29 in mesh pattern 26. Although this disclosure describes or illustrates particular conductive lines having a particular type of path, this disclosure contemplates conductive lines following any variation in line direction or path from a straight line, including, but not limited to, wavy lines or zig-zag lines.

In the example of FIG. 2C, mesh pattern 30 may be made from randomized micro-features. Substantially randomized conductive line 32 patterns may to avoid stretches of fine metal with a repeat frequency, reducing a probability of causing interference or moiré patterns. In particular embodiments, mesh pattern 30 substantially embodies a Voronoi diagram, with notional seeds (not shown) corresponding to Voronoi sites within mesh cells 34 corresponding to Voronoi cells. As an example and not by way of limitation, every point along each conductive line 32 may be substantially equidistant from its two closest notional seeds. The notional seeds do not correspond to any material (conductive or otherwise) in the touch sensor and the notional seeds serve to determine the randomized arrangement of conductive lines 32. Moreover, randomized micro-features of mesh pattern 30 may not substantially repeat with respect to an orientation of the touch sensor (such as horizontal, vertical, or angled).

Although this disclosure describes or illustrates particular mesh patterns (e.g. 20, 26, and 30), this disclosure contemplates any suitable mesh pattern formed using any suitable conductive material having any suitable configuration. Fine lines (e.g., 22A or 32) of conductive mesh patterns (e.g. 20, 26, and 30) may occupy the surface area of a shape in a hatched, mesh, or other suitable pattern. As an example and not by way of limitation, the fine lines (e.g. 22A or 32) of conductive material may have a total line density of less than approximately 10% of a surface area. Thus, the contribution of the conductive lines to the attenuation of light through mesh pattern (e.g. 20, 26, and 30) may be within a range of approximately 1 to approximately 10%. Accordingly, although conductive lines (e.g. 22A or 32) may be opaque, the combined optical transmittance of electrodes formed using mesh pattern (e.g. 20, 26, and 30) may be approximately 90% or higher, ignoring a reduction in transmittance due to other factors such as the substantially flexible substrate material.

The sheet resistance is a measure of resistance that may be used to characterize a material and is independent of the dimensions (e.g. length and width) of the particular shapes. Shapes formed from one or more cuts in mesh patterns 20, 24, and 30 the conductive material may be similarly characterized by an effective sheet resistance. The sheet resistance of shapes formed from example conductive materials may be approximated by the following equation:

$${R}_{S} = \frac{ρ}{t} \qquad ( 1 )$$

Rₛ has units of Ω/square and a square is the ratio of the length of the shape to its width, ρ is the resistivity of the conductive material, and t is the thickness of the conductive material. The effective sheet resistance may be defined as the edge to the opposite edge resistance of a suitably-sized square of the mesh pattern, e.g. 20, 24, and 30. The total effective resistance of a shape of the touch sensor may be approximated through the effective sheet resistance of the mesh pattern 20, 24, and 30 and the drawn length and width of the shape. As an example and not by way of limitation, the lines (e.g. 22A or 32) of conductive material may be copper or copper-based and have a thickness of approximately 5 μm or less and a width within a range of approximately 1 to approximately 10 μm. As another example, lines (e.g. 22A or 32) of conductive material may be silver or silver-based and similarly have a thickness of approximately 5 μm or less and a width within a range of approximately 1 to approximately 10 μm. In particular embodiments, the effective sheet resistance of conductive mesh patterns (e.g. 20, 24, and 30) may be adjusted through the density, width, thickness, or combination of these of the lines (e.g. 22A or 32) of conductive material. As an example and not by way of limitation, shapes formed from example conductive mesh patterns (e.g. 20, 24, and 30) described above may have an effective sheet resistance within a range of approximately 5 to approximately 20 Ω/square. As another example, the effective sheet resistance of shapes formed from example conductive mesh patterns (e.g. 20, 24, and 30) may be approximately 10 Ω/square.

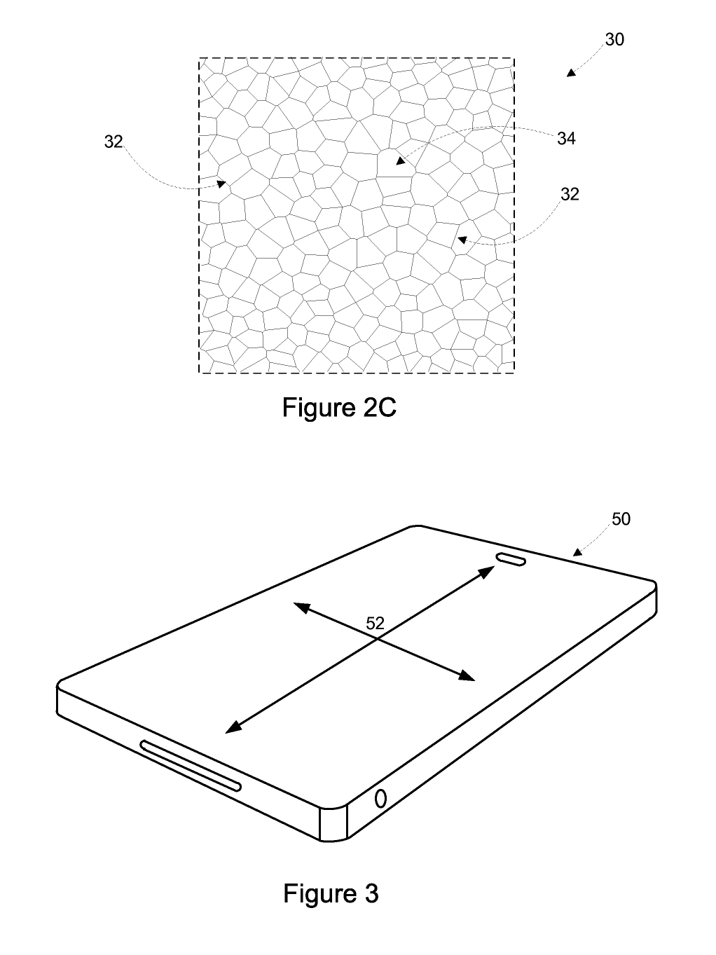

FIG. 3 illustrates an example device that incorporates a low-resistance touch-sensitive apparatus. As described above, examples of device 50 may include a smartphone, a PDA, a tablet computer, a laptop computer, a desktop computer, a kiosk computer, a satellite navigation device, a portable media player, a portable game console, a point-of-sale device, another suitable device, a suitable combination of two or more of these, or a suitable portion of one or more of these. In the example of FIG. 3, device 50 includes a touch sensor with a touch-sensitive area 52 and a display underneath the touch sensor. In particular embodiments, an image presented on a display underneath the touch sensor may be visible through the touch sensor. As an example and not by way of limitation, the display underneath the touch sensor may be a liquid crystal display (LCD), a light-emitting diode (LED) display, an LED-backlight LCD, or other suitable display. Although this disclosure describes and illustrates a particular display and particular display types, this disclosure contemplates any suitable device display and any suitable display types. As described above, the touch sensor of device 20 may have drive and sense electrodes disposed in a pattern on one side of a substrate or as an alternative may have drive electrodes disposed in a pattern on one side of a substrate and sense electrodes disposed in a pattern on another side of the substrate. As critical dimensions of electrodes decrease to achieve a higher density of electrodes and a length of electrodes increases to accommodate larger-sized touch sensors, the effective sheet resistance of the electrodes may become a design constraint to avoid increasing a charge-transfer time. As an example and not by way of limitation, one or more electrode patterns of the touch-sensitive apparatus with low-effective-sheet resistance may be formed from one or more cuts in a mesh pattern of conductive material, as described above.

Herein, reference to a computer-readable storage medium may include a semiconductor-based or other integrated circuit (IC) (such, as for example, a field-programmable gate array (FPGA) or an application-specific IC (ASIC)), a hard disk drive (HDD), a hybrid hard drive (HHD), an optical disc, an optical disc drive (ODD), a magneto-optical disc, a magneto-optical drive, a floppy disk, a floppy disk drive (FDD), magnetic tape, a holographic storage medium, a solid-state drive (SSD), a RAM-drive, a SECURE DIGITAL card, a SECURE DIGITAL drive, another suitable computer-readable storage medium, or a suitable combination of two or more of these, where appropriate. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

This disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative.

What is claimed is:

1. An apparatus comprising:
one or more substrates; and
a touch sensor disposed on one or more of the substrates, the touch sensor comprising one or more substantially transparent electrodes made of lines of substantially opaque conductive material, the substantially transparent electrodes having an effective sheet resistance within a range of approximately 5 to approximately 20 ohms per square.

2. The apparatus of claim 1, wherein the lines of substantially opaque conductive material form one or more conductive meshes.

3. The apparatus of claim 2, wherein one or more of the conductive meshes have an optical attenuation within a range of approximately 1% to approximately 10%.

4. The apparatus of claim 1, wherein the conductive material comprises carbon nanotubes, copper, or silver.

5. The apparatus of claim 1, wherein the lines of substantially opaque conductive material have widths within a range of approximately 1 to approximately 10 microns.

6. The apparatus of claim 1, wherein the effective sheet resistance of the substantially transparent electrodes is approximately 10 ohms per square.

7. The apparatus of claim 1, wherein one or more of the substrates are flexible.

8. The apparatus of claim 1, wherein the touch sensor is a mutual-capacitance touch sensor or a self-capacitance touch sensor.

9. The apparatus of claim 1, wherein:
the substantially transparent electrodes are all disposed only on one surface of one of the substrates; or
some of the substantially transparent drive electrodes are disposed on a first surface of one of the substrates and some of the transparent sense electrodes are disposed on a second surface of the one of the substrates opposite the first surface.

10. The apparatus of claim 1, wherein some of the substantially transparent drive electrodes are disposed on a surface of one of the substrates and some of the transparent sense electrodes are disposed on a surface of another of the substrates.

11. A device comprising:
a touch sensor disposed on one or more substrates, the touch sensor comprising one or more substantially transparent electrodes made of lines of substantially opaque conductive material, the substantially transparent electrodes having an effective sheet resistance within a range of approximately 5 to approximately 20 ohms per square; and
one or more computer-readable non-transitory storage media embodying logic that is configured when executed to control the touch sensor.

12. The device of claim 11, wherein the lines of substantially opaque conductive material form one or more conductive meshes.

13. The device of claim 11, wherein the conductive material comprises carbon nanotubes, copper, or silver.

14. The device of claim 11, wherein the lines of substantially opaque conductive material have widths within a range of approximately 1 to approximately 10 microns.

15. The device of claim 11, wherein the effective sheet resistance of the substantially transparent electrodes is approximately 10 ohms per square.

16. The device of claim 11, wherein:
the substantially transparent electrodes are all disposed only on one surface of one of the substrates; or
some of the substantially transparent drive electrodes are disposed on a first surface of one of the substrates and some of the transparent sense electrodes are disposed on a second surface of the one of the substrates opposite the first surface.

17. The device of claim 11, wherein some of the substantially transparent drive electrodes are disposed on a surface of one of the substrates and some of the transparent sense electrodes are disposed on a surface of another of the substrates.

18. The device of claim 11, wherein one or more of the substrates are flexible.

19. The device of claim 11, wherein the touch sensor is a mutual-capacitance touch sensor or a self-capacitance touch sensor.

20. The device of claim 11, further comprising a display located substantially underneath the touch sensor, the display being substantially visible through the touch sensor.
